(19) United States
(12) Patent Application Publication
(10) Pub. No.: US 2024/0330829 A1
(43) Pub. Date: Oct. 3, 2024

(54) OPTIMIZING USER RESEARCH AND OBJECT STRUCTURE OF WORKFLOWS

(71) Applicant: INTERNATIONAL BUSINESS MACHINES CORPORATION, Armonk, NY (US)

(72) Inventors: Jennifer M. Hatfield, Portland, OR (US); Stan Kevin Daley, Espanola, NM (US); Lucia Larise Stavarache, Columbus, OH (US); Marina-Adriana Mercioni, Timisoara (RO)

(73) Assignee: INTERNATIONAL BUSINESS MACHINES CORPORATION, Armonk, NY (US)

(21) Appl. No.: 18/194,365

(22) Filed: Mar. 31, 2023

(51) Int. Cl. G06Q 10/0639; G06Q 10/0633

(52) U.S. Cl. CPC G06Q 10/06393; G06Q 10/0633

(57) ABSTRACT

Optimizing a user experience (UX) through improved efficiency of UX research includes using a processor to identify a candidate object, associated with parameters, for research. A current state of the candidate object is assessed by the processor based on the parameters. This assessment may include performing simulations, performed by the processor, on the candidate object using different combinations of the parameters. Research methods are selected, by the processor, from research method recommendations generated for the candidate object based on key performance indicators (KPIs) determined according to the assessment. Machine learning logic is executed by the processor to evaluate the research methods for the candidate object using a machine learning model, and the candidate object and/or research methods is/are modified by the processor based on output from the machine learning model.

### BACKGROUND

The present invention relates in general to computing systems, and more particularly, to optimizing a user experience (UX) through improved efficiency of UX research of workflows performed on a product or platform by one or more computing processors.

### SUMMARY

According to an embodiment, a method for optimizing a UX through improved efficiency of UX research is provided. In certain implementations, one or more processors identify a candidate object, associated with parameters, for research. A current state of the candidate object is assessed by the one or more processors based on the parameters. This assessment may include performing simulations by the one or more processors on the candidate object using different combinations of the parameters. Research methods are selected, by the one or more processors, from research method recommendations generated for the candidate object based on key performance indicators (KPIs) determined according to the assessment. Machine learning logic is executed by the one or more processors to evaluate the research methods for the candidate object using a machine learning model, and the candidate object and/or research methods is/are modified by the one or more processors based on output from the machine learning model.

An embodiment includes a computer usable program product. The computer usable program product includes a computer-readable storage device, and program instructions stored on the storage device executable to perform similar functionality.

An embodiment includes a computer system. The computer system includes a processor, a computer-readable memory, and a computer-readable storage device, and program instructions stored on the storage device for execution by the processor via the memory to perform similar functionality.

### BRIEF DESCRIPTION OF THE DRAWINGS

FIG. 1 is a block diagram depicting a computing environment in which functions of the description may be performed.

FIG. 2 is a block diagram depicting a UX optimization system and modules illustrating a functional relationship between various functionalities performed by the system in the computing environment.

FIG. 3 is a flowchart illustrating a summarized computer-implemented method for automatic optimization of a UX through improved efficiency of UX research.

FIG. 4 is a flowchart illustrating a detailed computer-implemented method for automatic optimization of a UX through improved efficiency of UX research.

### DETAILED DESCRIPTION OF THE DRAWINGS

The technical solutions described herein facilitate the accelerating and optimizing of research collection methods for workflows and their associated user/product/platform. Further, the technical solutions presented herein facilitate the continuous learning, adapting, and optimizing of objects (e.g., a software product or platform) to contextually optimize existing workflows to enhance a UX of the objects. In a most simplest form, a workflow is a list of operations that a user and/or application is provided to execute in a specific order according to the workflow. In an example, one or more operations (workflow steps) of the workflow may alter a machine, for example, a machine on which the workflow is being executed. In another example, the one or more operations of the workflow may be workflow steps that process data on the machine by the user and/or application.

Examples of a workflow include a list of workflow steps for changing the hardware of a machine, for example, updating/replacing memory device from a computer, updating/replacing a battery from an automobile, changing a gear from a printer, or any other hardware change for a machine. Alternatively, or in addition, examples of a workflow include a list of workflow steps for changing software associated with a machine, for example updating/replacing an operating system, updating/replacing a software system, changing a configuration of a machine, such as encrypting the memory, setting one or more options of the software system, or any other software change for a machine. In another example, workflows in a business environment enable the sequencing of multiple inter-related tasks to solve needs of the business entity. Some of these inter-related tasks can be automated and some can be human related activities which aid in decision-making and branching during the workflow execution (e.g., a process flow). In still another example, a workflow may include one or more activities/applications and dependencies between one or more of the activities/applications.

It is to be understood that the foregoing is only a select few examples of workflows, and that each workflow is very domain and industry dependent (e.g., a workflow used at a bank may comprise very different operations and/or types of operations than a workflow used by a manufacturing company, and both workflows may comprise very different operations and/or types of operations than a workflow of an application running on a server). Some workflows may be referred to as “intelligent workflows”, which use machine learning techniques to contextually learn, adapt, and apply optimizations to a workflow to accelerate and more optimally (and/or perhaps more accurately) perform the workflow. That is, in some implementations, accelerating a performance of the workflow may implicate the workflow is performed more quickly, and more optimally performing the workflow may implicate the workflow is performed using less effort or computing resources and/or reducing a number of operations of the workflow while providing a satisfactory result.

Having these techniques in mind, user research of a product, for example, frequently is positioned as a one-time activity to determine the best approach for the design and development of experiences that meet a user's needs. This one-time activity during the development of a project is not sustainable for the lifetime of an experience with the product. Not having recurring and continuous research may in fact limit the life of a product, platform, or experience as user needs and technology changes quickly. An experience of the user could become non-optimal in a very short time period in today's fast paced environment if not monitored and optimized to not only meet, but also anticipate future experience and the user's needs.

For example, a company may invest heavily in the documentation, research and development of intelligent workflows for a product or service, which generally show their adoption in the market is mostly driven by users regardless of how innovative and optimal an intelligent workflow is. The technical solutions presented herein thus solve and scale an existing problem in the intelligent workflow space connected with the adoption and evolution of a product, being the “as-is” analysis discussed previously is generally manually performed, difficult to scale, and inconclusive, as a deep comparative analysis among clients with large data volume points cannot be conducted manually or during live production. Nor do current techniques generate insights and real-world recommendations to enhance the UX of the product. The technical solutions presented herein, rather, account for the dynamic nature of user's needs with respect to their UX with a product. For example, a workflow in a product in a banking industry is actively evolving, and its adoption is mandatory to maintain growth and remain competitive. Therefore, if the UX of the product and/or the workflow is sub-optimal, the adoption of the product/workflow will be considerably slower or non-existent.

Accordingly, the embodiments herein provide solutions to actively monitor, access, recommend, and even self-repair deficiencies in a product and/or workflow through an improved UX research framework. Having such a UX research framework to understand the intelligent workflow adoption and success criteria, and being able to adapt and adopt positive experiences can help in keeping an intelligent workflow (or a product and/or service associated with the intelligent workflow) up to date in the market and thereby increase its adoption among clients, industries, and domains. The research framework would optimally include the following considerations:

Comparative Analysis: Sometimes an intelligent workflow (e.g., of a product, platform, or service) is more successful with one client (or user) versus another client, and therefore post analysis research is done to understand why this happens and what can be learned. For example, several clients may be compared to one another to understand the breakdown and adoption of the intelligent workflow's specific tasks, activities, actors and interactions and their associated success rate. Clients with a similar workflow may be compared to analyze why some have better adoption than others (i.e., to determine whether elements exist where the UX experience and the interaction with the intelligent workflow could be improved or glitches that can be repaired).

Growth Generator: The analysis may include identifying a scope of the platform or product and determine adjustments, extending features, or re-design could bring greater satisfaction and fulfilment to users and increase and overall return on investment to meet long term objectives in growth.

Incremental Adoption Measurement: Implementing and adopting an intelligent workflow is not performed in one-step. Rather, the implementation of a meaningful workflow that raises productivity is a multi-step process which takes time and effort to implement correctly. Thus, the analysis may include the ability to measure the success and adoption rate to develop optimizations that incrementally increase the overall success of the product.

In some embodiments, at least some of the functionality described herein (e.g., generating models) is performed utilizing a cognitive analysis. The cognitive analysis may include classifying natural language, analyzing tone, and analyzing sentiment with respect to, for example, information associated with a particular product, platform, and/or service (e.g., workflow data), content and communications sent to and/or received by users, and/or other available data sources. In some embodiments, natural language processing (NLP), natural language understanding (NLU), and/or natural language generation (NLG) may be used to conduct research (e.g., determine a nature of interactions of workflows between a user/application and the particular product, platform, and/or service), determine working parameters, identify patterns (e.g., usage patterns), perform usage simulations, output recommendations to a user, and the like.

In some implementations, the cognitive analysis may include analyses on additional data which is not text-based. For example, Mel-frequency cepstral coefficients (MFCCs) (e.g., for audio content), and/or region-based convolutional neural network (R-CNN) pixel mapping (e.g., for images/videos), as are commonly understood, are used. As such, it should be understood that the methods/systems described herein may be applied to content other than text-based (or alphanumeric) content but also audio content and/or images/videos (e.g., an event associated with an entity is referenced in an audio and/or video file).

The processes described herein may utilize various information or data sources associated with users (e.g., users who are associated with and/or perform workflows using a particular product, platform, and/or service) and/or the product, platform, service, and/or workflow. With respect to users, the data sources may include, for example, any available data sources associated with the user. For example, in some embodiments, a profile (e.g., a cognitive profile) for the user(s) may be generated. Data sources that may be use used to generate a cognitive profile for the user(s) may include any appropriate data sources associated with the user that are accessible by the system (perhaps with the permission or authorization of the user). Examples of such data sources include, but are not limited to, communication sessions and/or the content (or communications) thereof (e.g., phone calls, video calls, text messaging, emails, in person/face-to-face conversations, etc.), a profile of (or basic information about) the user (e.g., job title, place of work, length of time at current position, family role, etc.), a schedule or calendar (i.e., the items listed thereon, time frames, etc.), projects (e.g., past, current, or future work-related projects), location (e.g., previous and/or current location and/or location relative to other users), social media activity (e.g., posts, reactions, comments, groups, etc.), browsing history (e.g., web pages visited), and online purchases.

With respect to the product, platform, service, and/or workflow, the data sources may include, for example, any available data sources associated with the product, platform, service, and/or workflow. Examples of such data sources include, but are not limited to, metrics, key performance indicators (KPIs), parameters, resource usage, simulation outcomes, usage patterns, machine learning model data (including forecasting data), and user feedback.

As such, in some embodiments, the methods and/or systems described herein may utilize a “cognitive analysis,” “cognitive system,” “machine learning,” “cognitive modeling,” “predictive analytics,” and/or “data analytics,” as is commonly understood by one skilled in the art. Generally, these processes may include, for example, executing machine learning logic or program code to receive and/or retrieve multiple sets of inputs, and the associated outputs, of one or more systems and processing the data (e.g., using a computing system and/or processor) to generate or extract models, rules, etc. that correspond to, govern, and/or estimate the operation of the system(s), or with respect to the embodiments described herein, the generation of research and UX optimization models, as described herein. Utilizing the models, the performance (or operation) of the system (e.g., utilizing/based on new inputs) may be predicted and/or the performance of the system may be optimized by investigating how changes in the input(s) effect the output(s). Feedback received from (or provided by) users and/or administrators may also be utilized, which may allow for the performance of the system to further improve with continued use.

In certain embodiments, the cognitive analyses described herein may apply one or more heuristics and machine learning based models using a wide variety of combinations of methods, such as supervised learning, unsupervised learning, temporal difference learning, reinforcement learning and so forth. Some non-limiting examples of supervised learning which may be used with the present technology include averaged one-dependence estimators (AODE), artificial neural network, backpropagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting. Some non-limiting examples of unsupervised learning which may be used with the present technology include artificial neural network, data clustering, expectation-maximization, self-organizing map, radial basis function network, vector quantization, generative topographic map, information bottleneck method, distributed autonomous entity systems based interaction (IBSEAD), association rule learning, apriori algorithm, Equivalence Class Clustering and bottom-up Lattice Traversal (ECLAT) algorithm, Frequent Pattern (FP)-growth algorithm, hierarchical clustering, single-linkage clustering, conceptual clustering, partitional clustering, k-means algorithm, fuzzy clustering, and reinforcement learning. Some non-limiting examples of temporal difference learning may include Quality (Q)-learning and learning automata. Specific details regarding any of the examples of supervised, unsupervised, temporal difference or other machine learning described in this paragraph are known and are considered to be within the scope of this disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as UX optimization module 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

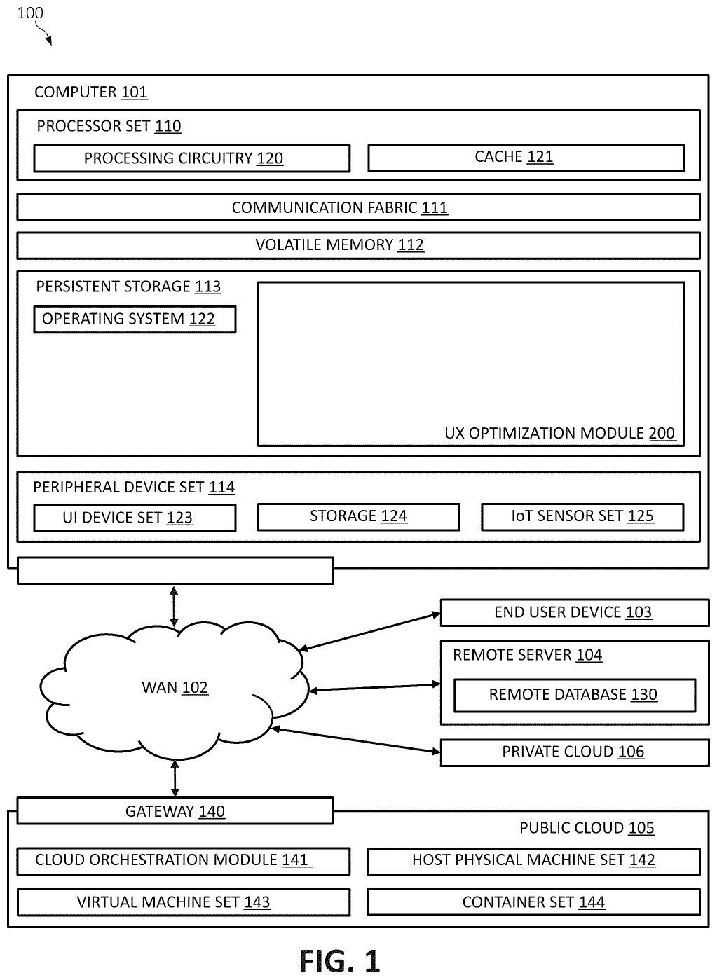

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

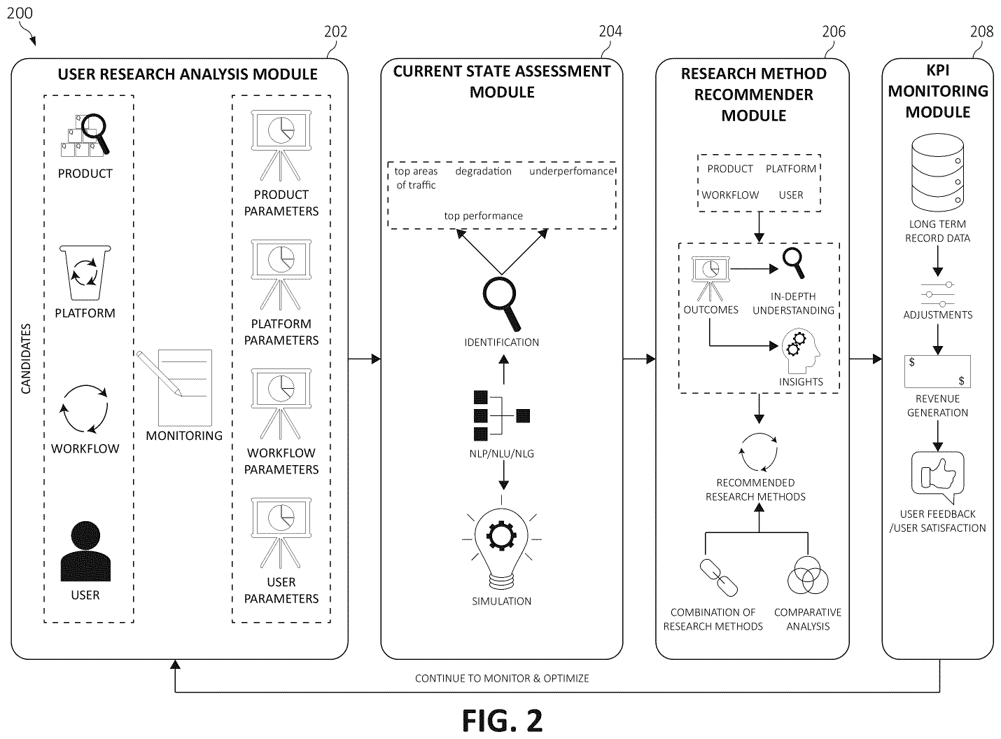

Turning now to FIG. 2, a block diagram further illustrating the UX optimization module 200 of FIG. 1 is depicted. As will be seen, many of the blocks in FIG. 2 may be considered “sub-modules” or “components” of the module's functionality; and one or more of the sub-modules, components, services, applications, and/or functions described in FIG. 2 are used in and/or executed by the computing environment of FIG. 1.

In an embodiment, UX optimization module 200 includes the components of a user research analysis module 202, a current state assessment module 204, a research method recommender module 206, and a KPI monitoring module 208. As one of ordinary skill in the art will appreciate, the depiction of the various functional units in the UX optimization module 200 is for purposes of illustration, as the functional units may be located and/or executed by the computer 101 or elsewhere within and/or between distributed computing components. Further, the individual components of the UX optimization module 200 may collectively represent a model, such as a machine learning model. That is, the inputs to the components described following may commensurately define inputs to train and generate the machine learning model (e.g., a “UX optimization model”) using machine learning techniques. The data and parameters described following may similarly represent the variables and/or features of the machine learning model, and the outputs described following may include a resultant output, prediction, and/or recommendation by the machine learning model. Said differently, each of the following components, and the respective functionality performed therein, may represent one or more steps and/or stages to train, generate, output, and optimize the machine learning model unless otherwise explicitly specified.

The user research analysis module 202 receives, as input, a candidate object for user research. This candidate object may comprise, for example, a product (e.g., a software product or application), a platform (e.g., a suite of applications, an operating system, or a general domain of the product), a workflow (e.g., a series of tasks completed in a certain order), and/or a user. The candidate object received by the user research analysis module 202 may be identified by a researcher (e.g., a user employed by an organization constructing the candidate object or employed by a third-party tasked with researching the candidate object), a client (e.g., user(s) which have purchased or otherwise acquired the candidate object for implementation), and/or a proposed system (e.g., a proposed software and/or hardware application associated with a use or dependency on the candidate system). Further, the identification of the candidate object may be based on new and/or existing user experience with the candidate object, new and/or existing intelligent workflows associated with the candidate object, and/or business or organizational requirements (e.g., an organization in a particular domain desiring to determine best practices to use the candidate object with respect to new or changing rules/procedures, new or existing processes, competitive strategy, or the like).

In certain implementations, the user research analysis module 202 continuously monitors the candidate object and determines, by user input and/or proposed system input, each of a plurality of parameters for the candidate object defining the tasks that establish an overall process, workflow, and/or site of the candidate object. This may include determining which of the parameters are measured from existing data and parameters identified from a current state assessment. For example, relevant parameters for the candidate object may be identified and extracted from existing data (e.g., stored in computing environment 100 or elsewhere), such as reviews of the candidate object (e.g., collected from a plurality of users), qualitative and quantitative metrics of the candidate object (e.g., resource usage, user sentiment or satisfaction, etc.), a number of active users using or associated with the candidate object, an amount of time spent by users and/or systems using the candidate object, a number of trials (or an average number of trials) necessary to develop and complete a satisfactory workflow involving the candidate object, outages and/or downtime of the candidate object, and deficiencies of the candidate object and/or the workflow involving the candidate object (e.g., bugs, glitches, etc.).

The current state assessment module 204 receives the monitored data and parameters of the candidate object from the user research analysis module 202 and performs a current state assessment of the candidate object. The current state assessment module 204 analyzes the data using, for example, NLP, NLU, and/or NLG techniques to identify particular metrics, such as high-traffic areas (or top areas of traffic), degradation, underperformance, and high-performance spaces of the candidate object. For example, the current state assessment module 204 may use NLP and NLU to parse and filter the existing data associated with the candidate object to identify, from many user reviews, particular user reviews which specifically reference a distinct problem with the candidate object. In another example, NLP and NLU may be used in conjunction with MFCC, R-CNN pixel mapping, or other techniques to identify a user sentiment toward the candidate object (or perhaps toward a specific touchpoint of the candidate object) through images, video, and/or audio, as previously described.

In certain embodiments, the current state assessment module 204 may use NLP, NLU, and/or NLG techniques to perform various simulations of the identified high-traffic areas, degradation, underperformance, and high-performance spaces of the candidate object in an attempt to reproduce real-world scenarios in which the candidate object may be utilized. For example, the current state assessment module 204 may identify a particular task or component (e.g., a plugin, a processing function, a task, etc.) causing an underperformance or otherwise unsatisfactory result or output of the candidate object, use NLP, NLU, and/or NLG to perform simulations attempting to reproduce or recreate the underperformance, and additional simulations using modified parameters (e.g., modifying parameters of the task or component, removal of the task or component, etc.) in an attempt to resolve or ameliorate the problem.

Likewise, the current state assessment module 204 may perform simulations on identified high-performance spaces of the candidate object in an attempt to identify methods, parameters, tasks, and the like to even further optimize those components and/or tasks. Further, the current state assessment module 204 may identify components and/or tasks of underperformance and execute various simulations to compare those components and/or tasks to similar, yet high performing components and/or tasks (of the candidate object or another candidate object, perhaps utilized by a different client) in attempt to identify “what works and why”, and utilize the resultant simulation determinations in attempt to improve those portions of the candidate object which are not currently optimal. In some implementations, these simulations may involve the generation of one or more additional machine learning models or neural networks, for example, to identify and analyze correlations between the components of the candidate object and/or alternative candidate object(s).

In certain embodiments, the research method recommender module 206 receives an output of the current state assessment module 204 in the form of the current state assessment of the candidate object. The current state assessment, as noted, includes insights obtained from the analysis of the candidate object which are provided as input to the research method recommender module 206. The research method recommender module 206 receives and/or retrieves the current state assessment to enhance a recommended research method to determine a more in-depth understanding of the candidate object to fill identified deficient areas. That is, the research recommender module 206 analyzes the current state assessment of the candidate object to identify, based on the assessment, which research method(s) (or combination of research method(s)) of a plurality of research methods used on the candidate object would likely yield the most insightful and actionable opportunities or results for short-term and long-term optimization of the candidate object.

The research method(s) identified and recommended by the research recommender module 206 may comprise any research method or type of research method commonly understood in the art. For example, the research method(s) may be qualitative and/or quantitative, and comprise, without limitation, interviewing, observation, sampling, A/B testing, product analysis, usability testing, focus groups, case studies, heuristic evaluation, parallel design, eye-tracking, tree-testing, competitor analysis, and benchmarking to name only a few.

In certain implementations, the research recommender module 206 may identify and output (e.g., on a list) one or more recommended research methods based on the analysis of the assessment. These research method(s) may be mixed-methods that are adaptable to the candidate object based on external inputs and variances. Further, the research recommender module 206 may perform comparative analyses with research methods used on alternative candidate object(s) (perhaps from a competitor or another vendor) in conjunction with the current state assessment to adapt or recommend research methods and/or provide insights and/or optimization recommendations (e.g., via output of a display device) to optimize or otherwise continue further in-depth research of the candidate object.

Research method(s) may then be selected (e.g., by a user and/or by the system) from the recommended research methods, and those research method(s) are established and applied to the candidate object. The selected and applied research method(s) may continue to be monitored for success and stored for further training (e.g., in additional stages or re-training) of the machine learning model and historical preferences. Further, modifications to the selected research method(s) and/or switching research method(s) during the monitoring may be recommended to generate additional insights and/or types of insights of the candidate object.

In certain embodiments, based on the current state assessment, simulations, and initial findings, KPIs are determined in conjunction with the research recommender module 206 by a KPI monitoring module 208. The KPIs may include any parameters associated with the candidate object, such as user satisfaction or sentiment (e.g., subsequent to improvements taken on the identified deficient area(s)) of the candidate object. The KPI monitoring module 208 may facilitate the storage and recordkeeping of long term (e.g., historical) data, record adjustments performed to the candidate object and an effect of the adjustment on one or more particular KPIs, monitoring of revenue generation and/or business/organizational requirements, user requirements, user sentiment and/or user feedback, and design usage patterns of the candidate object. The KPI monitoring module 208 may further research best practices of usage, tasks, workflow, etc. of the candidate object (e.g., as monitored from a plurality of users and/or organizations using the candidate object) and make attendant recommendations.

The KPI monitoring module 208 may further notify a user and/or system (e.g., by electronic messaging) when tasks, components, and/or workflows associated with a particular KPI of the candidate object have been determined to have a deficiency. The KPI monitoring module 208 may automatically identify, via the selected research method(s) and/or other comparative data, one or more identified solutions to improve or ameliorate the deficiency. In certain embodiments, the KPI monitoring module 208 automatically apply updates and recommendations to the candidate object based on the monitoring, simulations, and current state assessment(s). For example, in some implementations, thresholds and/or triggers may be set such that when a correspondent component, task, touchpoint, and/or workflow of the candidate object is detected as suboptimal, a recommendation may be provided to address the issue to the user and/or system and/or the solution may be automatically applied to the candidate object based on predefined preferences (e.g., updates and/or modifications to the workflow and/or updates and/or modifications to the candidate object).

In certain embodiments, the UX optimization module 200, via the user research analysis module 202, the current state assessment module 204, the research recommender module 206 and the KPI monitoring module 208 may engage in self-repair of the identified deficiencies of the candidate object based on the simulations of various scenarios and the identified updates through the user research. In some implementations, the thresholds and/or triggers may be established to guide the UX optimization module 200 as to those issues the system may automatically repair, modify and/or update, and those issues must be performed outside the system. In one example, the UX optimization module 200 may identify, through its components, that the design of a software application under research could be improved by making a modification to an interface of the application because a similar design used on another candidate object has found to include a higher adoption rate. In such an instance, a self-repair operation (according to predefined preferences allowing such an operation) may initiate to automatically update the interface of the candidate object.

In certain embodiments, the user research analysis module 202, the current state assessment module 204, the research recommender module 206 and the KPI monitoring module 208 of the UX optimization module 200 may comprise a feedback loop of continuous monitoring and optimizing. User feedback may be received and/or retrieved, for example, to update the parameters, research method(s), KPIs, and other metrics to continuously improve a performance of the system. For example, user feedback may be collected and used as input to iteratively re-train the machine learning model associated with the UX optimization module 200 to continuously enhance a performance and accuracy of the model (e.g., for recommending future research method(s), performing simulations, identifying deficiencies, and engaging in automatic self-repair of the candidate object and/or future candidate objects).

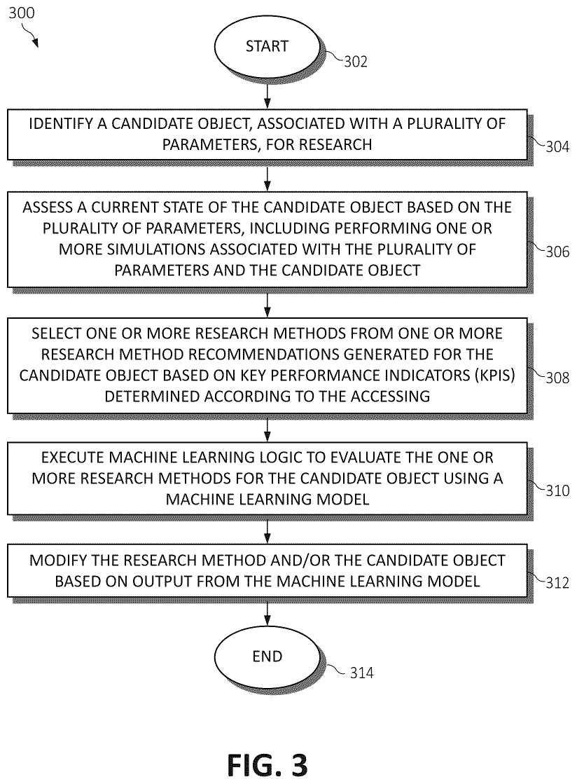

Turning now to FIG. 3, a computer-implemented method 300 for automatic optimization of a UX through improved efficiency of UX research is illustrated. It should be understood that the operations of the computer-implemented method 300 may be performed by the processor set 110 of the computer 101 depicted in the computing environment 100 of FIG. 1 by executing computer code of the UX optimization module 200, commensurate with the description of such in FIGS. 1 and 2.

Starting at step 302, one or more processors identify a candidate object for research, where the candidate object is associated with a plurality of parameters (step 304). The one or more processors access a current state of the candidate object based on the plurality of parameters, where the accessing includes performing one or more simulations associated with the plurality of parameters and the candidate object (step 306). The one or more processors select one or more research methods from one or more research method recommendations generated for the candidate object based on KPIs determined according to the accessing (step 308). Machine learning logic is executed by the one or more processors to evaluate the one or more research methods for the candidate object using a machine learning model (step 310). The one or more processors modify the candidate object and/or the one or more selected research methods based on output from the machine learning model (step 312). The method 300 then ends (step 314).

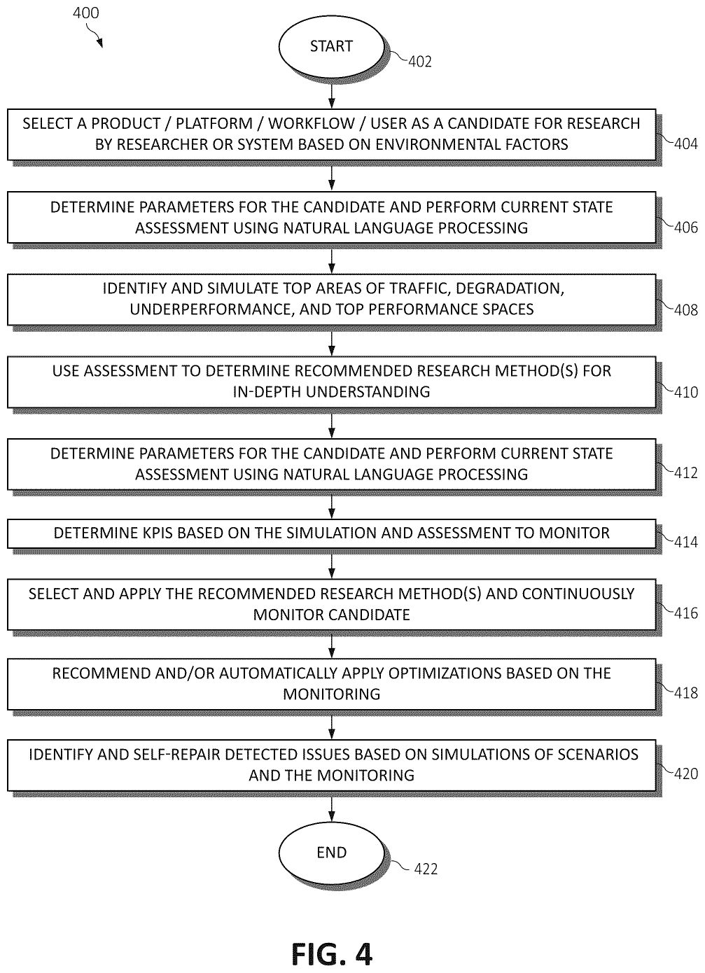

To further elaborate on the operations of the computer-implemented method 300, FIG. 4 illustrates an additional computer-implemented method 400 for automatic optimization of a UX through improved efficiency of UX research. It should be understood that the operations of the computer-implemented method 400 may be performed by the processor set 110 of the computer 101 depicted in the computing environment 100 of FIG. 1 by executing computer code of the UX optimization module 200, commensurate with the description of such in FIGS. 1-3.

Starting at step 402, a product, platform, workflow, and/or user is selected by one or more processors as a candidate for research by a researcher and/or system based on environmental factors (step 404). These environmental factors include, for example, new or existing user experience, workflows (including intelligent workflows), and business/organizational needs or requirements. The one or more processors determine parameters for the candidate object and perform a current state assessment using natural language processing techniques (e.g., NLP, NLU, and/or NLG) (step 406). Top areas of traffic, degradation, underperformance, and top performance spaces of the candidate object are identified by the one or more processors (step 408). The current state assessment is used by the one or more processors to determine recommended research method(s) (or combinations of research method(s)) for in-depth understanding of the candidate object (step 510).

At step 412, the one or more processors determine which of the parameters should be monitored for the candidate object and perform simulations using the natural language processing to attempt to identify deficient areas in conjunction with the current state assessment. The one or more processors determine KPIs for the candidate object which should be monitored, recorded, and stored based on the assessment and the simulations (step 414). One or more of the recommended research method(s) suggested by the system are selected and applied by the one or more processors to continuously monitor the candidate object (and particularly the KPIs) (step 416). Optimizations and/or modifications may be recommended and/or automatically applied to the candidate object by the one or more processors (step 418), and the one or more processors may identify and self-repair detected issues based on the current state assessment, simulations, and monitoring (step 420). Steps 404-420, as noted, represent a feedback loop in which machine learning is utilized to continuously improve and iteratively update and enhance the collective throughput of the system. The method 400 ends at step 422.

In an embodiment consistent with the operations of the computer implemented methods 300 and 400, the candidate object is selected from the group consisting of a product, a platform, a workflow, and a user.

In an embodiment consistent with the operations of the computer implemented methods 300 and 400, the identifying of the candidate object is based on a selection from the group consisting of new user experience, existing user experience, IWs, and user requirements. In one aspect, the user requirements may be business requirements of a business entity using the candidate object.

In an embodiment consistent with the operations of the computer implemented methods 300 and 400, the assessing further comprises identification of highest traffic areas, degradation, underperformance, and highest performance of the candidate object.

In an embodiment consistent with the operations of the computer implemented methods 300 and 400, the selecting of the one or more research methods further comprises a selection based on a combination of research methods from the one or more research method recommendations.

In an embodiment consistent with the operations of the computer implemented methods 300 and 400, research method capabilities and research method successes of the one or more research methods are stored for inclusion in the machine learning model.

In an embodiment consistent with the operations of the computer implemented methods 300 and 400, the modifying of the candidate object further comprises modifying the one or more research methods, and the modifying is further based on continuous monitoring comprising KPI, productivity, user sentiment and design usage patterns. In one aspect, the productivity is based on revenue generation of a business entity using the candidate object.

In an embodiment consistent with the operations of the computer implemented methods 300 and 400, the modifying of the candidate object further comprises performing an automatic self-repair operation of identified deficiencies of the candidate object based on an outcome of the one or more simulations.

In an embodiment consistent with the operations of the computer implemented methods 300 and 400, feedback with respect to the output from the machine learning model is received and used to iteratively optimize the machine learning model.

It should be noted that, as used herein, the terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

In general, as may be used herein, “optimize” may refer to and/or defined as “maximize,” “minimize,” “best,” or attain one or more specific targets, objectives, goals, or intentions. Optimize may also refer to maximizing a benefit to a user (e.g., to create a better UX through improved UX research and modification of an object of the UX). Optimize may also refer to making the most effective or functional use of a situation, opportunity, or resource.

Additionally, optimizing need not refer to a best solution or result but may refer to a solution or result that is “good enough” for a particular application, for example. In some implementations, an objective is to suggest a “best” combination of research methods, parameters, workflow designs, and/or modifications to a product, platform, and/or service. Herein, the term “optimize” may refer to such results based on minima (or maxima, depending on what parameters are considered in the optimization problem). In an additional aspect, the terms “optimize” and/or “optimizing” may refer to an operation performed in order to achieve an improved result such as reduced execution costs or increased resource utilization, whether or not the optimum result is actually achieved. Similarly, the term “optimize” may refer to a component for performing such an improvement operation, and the term “optimized” may be used to describe the result of such an improvement operation.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary, a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer-implemented method for automatic optimization of a user experience (UX) through improved efficiency of UX research, the computer-implemented method comprising:
identifying, by one or more processors, a candidate object for research, wherein the candidate object is associated with a plurality of parameters;
assessing, by the one or more processors, a current state of the candidate object based on the plurality of parameters, wherein the accessing includes performing one or more simulations associated with the plurality of parameters and the candidate object;
selecting, by the one or more processors, one or more research methods from one or more research method recommendations generated for the candidate object based on key performance indicators (KPIs) determined according to the accessing;
executing machine learning logic, by the one or more processors, to evaluate the one or more research methods for the candidate object using a machine learning model; and
modifying, by the one or more processors, the candidate object based on output from the machine learning model.

2. The computer-implemented method of claim 1, wherein:
the candidate object is selected from the group consisting of a product, a platform, a workflow, and a user; and
the identifying of the candidate object is based on a selection from the group consisting of new user experience, existing user experience, intelligent workflows (IWs), and user requirements.

3. The computer-implemented method of claim 1, wherein:
the assessing further comprises identification of highest traffic areas, degradation, underperformance, and highest performance of the candidate object; and
the selecting of the one or more research methods further comprises a selection based on a combination of research methods from the one or more research method recommendations.

4. The computer-implemented method of claim 1, further including storing, by the one or more processors, research method capabilities and research method successes of the one or more research methods for inclusion in the machine learning model.

5. The computer-implemented method of claim 1, wherein the modifying of the candidate object further comprises modifying the one or more research methods, and wherein the modifying is further based on continuous monitoring of the KPIs, productivity, user sentiment and design usage patterns.

6. The computer-implemented method of claim 1, wherein the modifying of the candidate object further comprises performing an automatic self-repair operation of identified deficiencies of the candidate object based on an outcome of the one or more simulations.

7. The computer-implemented method of claim 1, further comprising receiving feedback with respect to the output from the machine learning model, wherein the feedback is used to iteratively optimize the machine learning model.

8. A system for automatic optimization of a user experience (UX) through improved efficiency of UX research, comprising:
one or more processors; and
one or more memory storing instructions executed by the one or more processors, the instructions, when executed, causing the one or more processors to:
identify a candidate object for research, wherein the candidate object is associated with a plurality of parameters;
assess a current state of the candidate object based on the plurality of parameters, wherein the accessing includes performing one or more simulations associated with the plurality of parameters and the candidate object;
select one or more research methods from one or more research method recommendations generated for the candidate object based on key performance indicators (KPIs) determined according to the accessing;
execute machine learning logic to evaluate the one or more research methods for the candidate object using a machine learning model; and
modify the candidate object based on output from the machine learning model.

9. The system of claim 8, wherein:
the candidate object is selected from the group consisting of a product, a platform, a workflow, and a user; and
the identifying of the candidate object is based on a selection from the group consisting of new user experience, existing user experience, intelligent workflows (IWs), and user requirements.

10. The system of claim 8, wherein:
the assessing further comprises identification of highest traffic areas, degradation, underperformance, and highest performance of the candidate object; and
the selecting of the one or more research methods further comprises a selection based on a combination of research methods from the one or more research method recommendations.

11. The system of claim 8, wherein, when executed, the executable instructions further cause the one or more processors to store research method capabilities and research method successes of the one or more research methods for inclusion in the machine learning model.

12. The system of claim 8, wherein the modifying of the candidate object further comprises modifying the one or more research methods, and wherein the modifying is further based on continuous monitoring of the KPIs, productivity, user sentiment and design usage patterns.

13. The system of claim 8, wherein the modifying of the candidate object further comprises performing an automatic self-repair operation of identified deficiencies of the candidate object based on an outcome of the one or more simulations.

14. The system of claim 8, wherein, when executed, the executable instructions further cause the one or more processors to receive feedback with respect to the output from the machine learning model, wherein the feedback is used to iteratively optimize the machine learning model.

15. A computer program product for automatic optimization of a user experience (UX) through improved efficiency of UX research, the computer program product comprising:
one or more computer readable storage media, and program instructions collectively stored on the one or more computer readable storage media, the program instructions comprising:
program instructions to identify, by one or more processors, a candidate object for research, wherein the candidate object is associated with a plurality of parameters;
program instructions to assess, by the one or more processors, a current state of the candidate object based on the plurality of parameters, wherein the accessing includes performing one or more simulations associated with the plurality of parameters and the candidate object;
program instructions to select, by the one or more processors, one or more research methods from one or more research method recommendations generated for the candidate object based on key performance indicators (KPIs) determined according to the accessing;
program instructions to execute machine learning logic to evaluate, by the one or more processors, the one or more research methods for the candidate object using a machine learning model; and
program instructions to modify, by the one or more processors, the candidate object based on output from the machine learning model.

16. The computer program product of claim 15, wherein:
the candidate object is selected from the group consisting of a product, a platform, a workflow, and a user; and
the identifying of the candidate object is based on a selection from the group consisting of new user experience, existing user experience, intelligent workflows (IWs), and user requirements.

17. The computer program product of claim 15, wherein:
the assessing further comprises identification of highest traffic areas, degradation, underperformance, and highest performance of the candidate object; and
the selecting of the one or more research methods further comprises a selection based on a combination of research methods from the one or more research method recommendations.

18. The computer program product of claim 15, further including program instructions to store, by the one or more processors, research method capabilities and research method successes of the one or more research methods for inclusion in the machine learning model.

19. The computer program product of claim 15, wherein the modifying of the candidate object further comprises:
modifying the one or more research methods, and wherein the modifying is further based on continuous monitoring of the KPIs, productivity, user sentiment and design usage patterns; and
performing an automatic self-repair operation of identified deficiencies of the candidate object based on an outcome of the one or more simulations.

20. The computer program product of claim 15, further including program instructions to receive feedback with respect to the output from the machine learning model, wherein the feedback is used to iteratively optimize the machine learning model.
